(19) United States
(12) Patent Application Publication
(10) Pub. No.: US 2023/0259856 A1
(43) Pub. Date: Aug. 17, 2023

(54) PROJECT SUCCESS PROBABILITY CALCULATION SYSTEM, METHOD OF CALCULATING PROJECT SUCCESS PROBABILITY, AND NON-TRANSITORY COMPUTER-READABLE MEDIUM

(71) Applicant: MANAGEMENT SOLUTIONS CO., LTD., Tokyo (JP)

(72) Inventors: Shinya TAKAHASHI, Tokyo (JP); Toshinari GOTO, Tokyo (JP); Akira KANEKO, Tokyo (JP); Ryo HASEGAWA, Tokyo (JP); Yi ZHANG, Tokyo (JP)

(73) Assignee: MANAGEMENT SOLUTIONS CO., LTD., Tokyo (JP)

(21) Appl. No.: 18/138,579

(22) Filed: Apr. 24, 2023

Related U.S. Application Data
(63) Continuation of application No. PCT/JP2021/039672, filed on Oct. 27, 2021.

(30) Foreign Application Priority Data
Oct. 30, 2020 (JP) 2020-183165

(51) Int. Cl. G06Q 10/0635; G06Q 10/0637; G06Q 10/10

(52) U.S. Cl. CPC G06Q 10/0635; G06Q 10/06375; G06Q 10/103

(57) ABSTRACT

Provided is a project success probability calculation system including a performance influencing pre-element holder that holds a performance influencing pre-element which is a pre-element that influences the performance of a project, a questioner that outputs a question for associating a performance pre-status value with the performance influencing pre-element assuming a specific project in which the project is specifically specified and prompts an input, a probability distribution derivation function holder that holds a probability distribution derivation function which is a function for calculating a probability distribution of success of the specific project using the performance pre-status value associated with the performance influencing pre-element, a success probability distribution calculator that calculates a success probability distribution of the specific project, based on the performance pre-status value obtained by the input and the held probability distribution derivation function, and a success probability distribution holder that holds the calculated success probability distribution.

### CROSS-REFERENCE TO RELATED APPLICATION

This application is a continuation application of International Application PCT/JP2021/039672 filed on Oct. 27, 2021 and designated the U.S., which claims the benefits of priorities of Japanese Patent Application No. 2020-183165 filed on Oct. 30, 2020, the entire contents of which are incorporated herein by reference.

### FIELD

The present invention relates to a system, a method, and a non-transitory computer-readable medium for judging the probability of success of a so-called project based on multilateral and social empirical rules.

### BACKGROUND

An idea of diagnosing a success probability of a project has existed conventionally. An example thereof is Patent Document 1 (Japanese Laid-open Patent Publication No. 2016-170718).

### SUMMARY

According to an aspect of the present disclosure, there is provided a project success probability calculation system including: a performance influencing pre-element holder configured to hold a performance influencing pre-element which is a pre-element that influences the performance of a project and is empirically known to influence the success of the project; a questioner configured to output a question for associating a performance pre-status value with the performance influencing pre-element assuming a specific project in which the project is specifically specified and prompt an input, wherein the performance pre-status value is one or more of a numerical value which is a value of the specific project, presence or absence, YES or NO, a level, and an option; a probability distribution derivation function holder configured to hold a probability distribution derivation function which is a function for calculating a probability distribution of success of the specific project using the performance pre-status value associated with the performance influencing pre-element; a success probability distribution calculator configured to calculate a success probability distribution of the specific project receiving the input by the questioner, based on the performance pre-status value associated with the performance influencing pre-element obtained by the input to the questioner and the probability distribution derivation function held in the probability distribution derivation function holder; and a success probability distribution holder configured to hold the calculated success probability distribution.

In addition to the above features, the project success probability calculation system may further include: a desired success probability information acquirer configured to acquire desired success probability information which is information about a desired success probability; and a realization probability calculator configured to calculate a realization probability which is a probability of realizing the desired success probability based on the held success probability distribution and the acquired desired success probability information.

In addition to the above features, the project success probability calculation system may further include: an influence degree acquirer configured to acquire an influence degree of the performance pre-status value associated with the performance influencing pre-element on the realization probability; an advice acquisition rule holder configured to hold an advice acquisition rule which is a rule for acquiring an advice on the performance influencing pre-element assuming the performance pre-status value in order to improve the realization probability; an advice acquirer configured to acquire an advice on the performance influencing pre-element based on the acquired influence degree and the advice acquisition rule; and an advice outputter configured to output the acquired advice.

In addition to the above features, the probability distribution derivation function may be a function corrected by a combination of machine learning and Bayesian statistics.

According to another aspect of the present disclosure, there are provided a method of calculating a project success probability and a non-transitory computer-readable medium which correspond to the project success probability calculation system described above.

According to still another aspect of the present disclosure, there is provided a project success probability calculation system including: a performance influencing pre-element identification information holder configured to hold performance influencing pre-element identification information for identifying a performance influencing pre-element which is a pre-element that influences the performance of a project and is empirically known to influence the success of the project; a questioner configured to output a question for associating a performance pre-status value with the performance influencing pre-element identification information assuming a specific project in which the project is specifically specified and prompt an input, wherein the performance pre-status value is one or more of a numerical value which is a value of the specific project, presence or absence, YES or NO, a level, and an option; a probability distribution derivation function holder configured to hold a probability distribution derivation function which is a function for calculating a probability distribution of success of the specific project using the performance pre-status value associated with the performance influencing pre-element identification information; a success probability distribution calculator configured to calculate a success probability distribution of the specific project receiving the input by the questioner, based on the performance pre-status value associated with the performance influencing pre-element identification information obtained by the input to the questioner and the probability distribution derivation function held in the probability distribution derivation function holder; and a success probability distribution holder configured to hold the calculated success probability distribution.

As described above, it is possible to calculate the success probability distribution of the project without calculating a specific value as the success probability of the project or calculating a range of a specific probability, and by using this success probability distribution, it is possible to calculate a probability of achieving a success probability higher than a predetermined success probability, that is, a probability of probability. It also provides an advice necessary for the project to improve the probability of probability. As a result, it was possible to obtain more detailed information on the success probability of the project which had been answered in linear function according to the satisfaction of the project success factor until now, and along with this, the probability of the success probability of the project and matters to be solved in order to improve the success probability of the project were clarified in advance.

### BRIEF DESCRIPTION OF THE DRAWINGS

FIG. 1 is a diagram illustrating a functional configuration of a project success probability calculation system according to a first embodiment:

FIGS. 2A to 2C are diagrams illustrating a hardware configuration of the project success probability calculation system according to the first embodiment:

FIG. 3 is a flowchart illustrating a process when the project success probability calculation system according to the first embodiment is used:

FIG. 4 is a diagram illustrating a functional configuration of a project success probability calculation system according to a second embodiment;

FIGS. 5A to 5C are diagrams illustrating a hardware configuration of the project success probability calculation system according to the second embodiment:

FIG. 6 is a flowchart illustrating a process when the project success probability calculation system according to the second embodiment is used;

FIG. 7 is a diagram illustrating a functional configuration of a project success probability calculation system according to a third embodiment;

FIGS. 8A to 8C are diagrams illustrating a hardware configuration of the project success probability calculation system according to the third embodiment;

FIG. 9 is a flowchart illustrating a process when the project success probability calculation system according to the third embodiment is used; and

FIG. 10 is a diagram illustrating a success probability distribution.

### DESCRIPTION OF EMBODIMENTS

Patent Document 1 discloses a technical idea or problem of diagnosing the success probability of the project.

However, in Patent Document 1, for example, it is not the case of “making each item be selected and diagnosing on the basis of the selected result”. As for projects, the probability of success is different for each client and each project, and there was no system to predict the probability of success or failure or to offer an advice for reaching the “possibility of success”, in relation to the “possibility of success”.

In the present disclosure, in consideration of such a problem, a system is developed to issue a question for each item which is grasped by an empirical rule to affect the performance of a project, selects a degree (value) to affect the performance of the project by making a user answer the question, and acquires and outputs a probability distribution of the success of the project based on the selected result. As for projects, the possibility of success differs for each client and each project, and the system is developed to provide the probability of reaching the “possibility of success” and an advice for reaching it based on the degree of influence on the performance of the project obtained from the answer.

Hereinafter, embodiments of the present disclosure will be described with reference to the accompanying drawings. The interrelationships between embodiments and claims are as follows. The description of a first embodiment relates to claims 1, 4, 5, 8, 9, 12 and 13. The description of a second embodiment relates to claims 2, 6 and 10. The description of a third embodiment relates to claims 3, 7 and 11. The third embodiment includes the features of the first and second embodiments, and the second embodiment includes the features of the first embodiment.

Each claim is not limited to the above embodiments, and various changes and modifications may be made to the embodiments without departing from the scope of the invention disclosed in the claims.

<Hardware Capable of Executing the Present Disclosure>

In principle, this disclosure uses a computer, but it can be realized by software, by hardware, or by the collaboration of software and hardware. The hardware that realizes all or a part of elements in each claim includes the basic components of a computer such as a CPU (Central Processing Unit), a memory, a bus, an input/output device, various peripheral devices, and a user interface.

Various peripheral devices include storage devices, interfaces such as Internet, devices connected to Internet, displays, keyboards, mice, speakers, cameras, video devices, televisions, various sensors for monitoring production status in laboratories or factories (e.g. flow sensors, temperature sensors, weight sensors, liquid volume sensors, infrared sensors, shipping piece counters, packing piece counters, foreign material inspection devices, defective product counters, radiation inspection devices, surface condition inspection devices, circuit inspection devices, motion sensors, worker work status monitoring devices (by video, ID, PC workload, etc.). CD machines, DVD (Digital Versatile Disc) machines, Blu-ray machines, USB (Universal Serial Bus) memory, USB memory interface, removable hard disks, general hard disks, projector devices, SSDs (Solid State Drive), telephones, fax machines, copiers, printing devices, movie editing devices, various sensor devices, or the like.

This system does not necessarily have to be configured by one housing, but may be configured by combining a plurality of housings by communication. The communication may be a LAN (Local Area Network), WAN (Wide Area Network). Wi-fi (registered trademark), Bluetooth (registered trademark), infrared communication, ultrasonic communication, and a part of the communication may be installed across national borders. Furthermore, each of the plurality of housings may be operated by a different operational entity, or by a single operational entity. It does not matter whether the system of the present disclosure is operated by one or more entities. In addition to this system, the invention can be configured as a system including a terminal used by a third party and a terminal used by another third party. In addition, these terminals may be installed across national borders. Furthermore, in addition to this system and the terminals, a device used for registering related information and related persons of a third party, a device used for a database for recording the contents of registration, and the like may be prepared. These devices may be provided in this system, or they may be provided outside of this system, and this system may be configured to make information of these devices available.

<Sufficiency of Use of Natural Law>

This invention works in cooperation with a computer, communication facilities, and software. This invention makes it possible not only to use ICT (Information and Communication Technology) to handle processes that were previously done by project participants in interviews, but also to use ICT to determine the effects of many complex information exchanges, procedures, authentication, and settlements related to projects, and to support the accumulation, retention, and exchange of effective information via ICT that meets all the necessary requirements that could not be created without skill. This invention is a so-called business model patent because it includes a process unique to ICT. In addition, various types of identification information, risk information, issue information, and task information are held or processed in each part. From this point of view, if the invention is judged on the basis of the resources such as computers described in the claims and the specification, and the common sense of the art related to those matters, the invention is based on the use of natural laws.

<Significance of Use of Natural Law as Required by Patent Law>

The use of the laws of nature required by the Patent Law is required to ensure that an invention is industrially useful from the viewpoint that the invention must have industrial applicability and contribute to the development of industry, based on the purpose of the law. In other words, it requires that the invention be industrially useful, i.e., that the effect of the invention declared in the application can be reproduced with a certain degree of certainty through the implementation of the invention. From this point of view, natural law usability is interpreted to mean that the function of each of the invention specific matters (invention constituent requirements), which are the composition of the invention to realize the effect of the invention, should utilize natural laws. Furthermore, the effect of an invention should be the possibility of providing a given usefulness to the users of the invention, not how the users feel or think about the usefulness. Therefore, even if the effect that the user obtains from this system is a psychological effect, the effect itself is an event that is not subject to the required natural law usability.

### First Embodiment

<Configuration of First Embodiment>

This embodiment provides a project success probability calculation system including: a performance influencing pre-element holding unit configured to hold a performance influencing pre-element which is a pre-element that influences the performance of a project and is empirically known to influence the success of the project; a question unit configured to output a question for associating a performance pre-status value with the performance influencing pre-element assuming a specific project in which the project is specifically specified and prompt an input, wherein the performance pre-status value is one or more of a numerical value which is a value of the specific project, presence or absence, YES or NO, a level, and an option; a probability distribution derivation function holding unit configured to hold a probability distribution derivation function which is a function for calculating a probability distribution of success of the specific project using the performance pre-status value associated with the performance influencing pre-element; a success probability distribution calculating unit configured to calculate a success probability distribution of the specific project receiving the input by the question unit, based on the performance pre-status value associated with the performance influencing pre-element obtained by the input to the question unit and the probability distribution derivation function held in the probability distribution derivation function holding unit; and a success probability distribution holding unit configured to hold the calculated success probability distribution.

Hereinafter, the functional configuration, the hardware configuration, and the process flow of the project success probability calculation system according to the present embodiment will be described in order.

<Functional Configuration of First Embodiment>

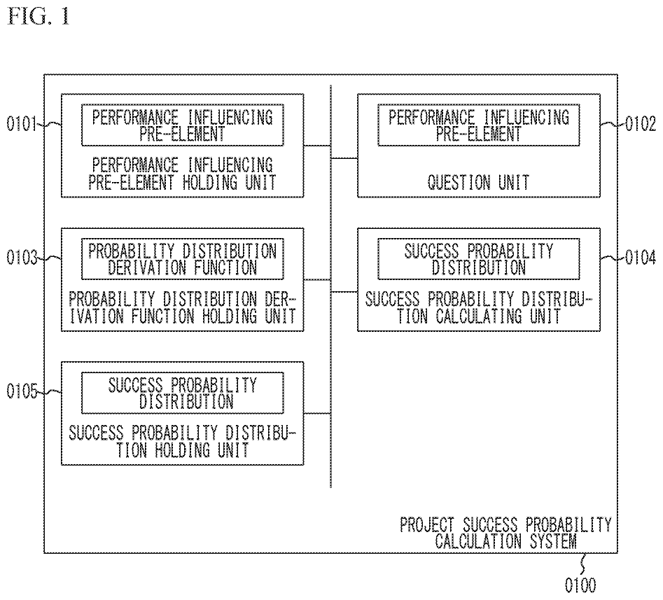

FIG. 1 is a diagram illustrating a functional configuration of the project success probability calculation system according to the first embodiment. The project success probability calculation system 0100 according to the present embodiment includes a performance influencing pre-element holding unit 0101, a question unit 0102, a probability distribution derivation function holding unit 0103, a success probability distribution calculating unit 0104, and a success probability distribution holding unit 0105.

The performance influencing pre-element holding unit 0101 has a function of holding a performance influencing pre-element which is a pre-element that influences the performance of a project and is empirically known to influence the success of the project. It should be noted that the performance influencing pre-element may be read as performance influencing pre-element identification information which is information for identifying the performance influencing pre-element throughout this specification. Further, in the configuration related to advice acquisition and advice output, it is also possible to use the performance influencing pre-element, and in the other configuration, it is also possible to use the performance influencing pre-element identification information.

The “performance influencing pre-element” is a pre-element that influences the performance of a project and is empirically known to influence the success of the project. However, the performance influencing pre-element is not necessarily limited to information before the start of the project, and it may include information that influences the future of the project during the performance of the project. In this way, the accuracy of the success probability distribution can be known with more certainty during the performance of the project by not necessarily limiting it to the information before the start of the project. Therefore, by repeatedly inputting, into the probability distribution derivation function, a value associated with the performance influencing pre-element assumed to be closer to the reality from before the start of the project to during the performance of the project, it is possible to perform the project while increasing the possibility of leading the project to success.

Specifically, the performance influencing pre-element mainly refers to human resources such as people who are put into or involved in the project and can influence the people who are involved in the project, capital that can be invested in the project or elements that influence capital that can be invested in the project, materials required for the project that must be prepared in advance, or elements that influence the procurement of such materials. However, in addition to the above, other factors that influence the assumed social infrastructure may be included. The assumed social infrastructure includes transportation infrastructure (for example, the economy stagnated due to the impact of the novel coronavirus in recent years), communication infrastructure (for example, large-scale network failure), and economic infrastructure (for example, market functions such as foreign exchange market, stock market, bond market, government bond market, crude oil market, precious metal market, grain market, interest rate market). The assumed social infrastructure may also be taken into account as the performance influencing pre-element. In addition, the social situation may become the performance influencing pre-element. The social situation is mainly the international situation. A recent example is the trade friction between the United States and China. By this, Huawei in China rapidly dropped the sales, and electronic component manufacturers in Japan also stopped the shipment to Huawei and received large economic damage. In this way, there are cases in which various elements of the international situation are grasped as the performance influencing pre-element and considered in the system. Major factors that influence the international situation include the political systems of each country, statements by the leaders of each country, military actions of some countries, and scandals involving the leaders of some countries. In some cases, biased reporting by the mass media is added as an element. Specific examples of the typical performance influencing pre-element are given below. A value obtained regarding the performance influence pre-element is a performance pre-status value. Hereinafter, “value” shall be read as “performance pre-status value” as appropriate. The performance influencing pre-element may include one or more of the following elements. It should be noted that the performance influencing pre-element is not limited to the elements described below, but necessary elements are selected according to the characteristic of the project and the probability distribution derivation function to be used.

<<Human Resources>>

<Human Resources 1: Information on the Number of Persons Who can be Put into Project>

As human resources or elements related to them, “the number of persons who can be put into the project” can be mentioned first. This does not necessarily have to be the number of persons. For example, in the case of planning the required number of persons with predetermined project performance skills according to the skills, the information on which skills of persons can be arranged for the number of planned persons becomes a factor of the representative performance influencing pre-element on human resources. For example, when there is a concept of a project in which it is necessary to arrange 10 persons with a skill A, a degree of possibility of arranging the number of persons with the skill is the value. For example, if it is possible to arrange 15 persons, there is a margin, and hence 100 (%: a numerical value representing satisfaction) can be assigned to the value of the performance influencing pre-element as a value satisfying it. However, when only 10 persons can be arranged, 80 (%: numerical value representing satisfaction) is assigned as the value because there is no margin and there is a possibility that the element cannot be satisfied due to some accidental reason. In this way, a predetermined value corresponding to the status is assigned to each item of the performance influencing pre-element according to the actual situation. In reality, it is composed so that a project manager inputs (selection from alternatives, etc.) and the system assigns the value to the element.

<Human Resources 2: Abilities of Participants in the Project>

As an example of “ability of a person who participates in the project”, a degree of familiarity with a database language used in the project can be cited. It is an important element when the purpose of the project is to build a database on some kind of data. The database language elements are classified into Data Manipulation Language (DML): language or language element for retrieval, new registration, update, and deletion of target data), Data Definition Language (DDL): language or language element for creation, update, and deletion of data structure), and Data Control Language (DCL): language or language element for access control. For example, in SQL (Structured Query Language) which is a popular database language, all the above-mentioned language elements exist as a language system in which various instruction statements are combined into one. Depending on the section assigned to each participant, the degree of familiarity with each language, past experience, knowledge of surrounding technologies, and familiarity with related API (Application Programming Interface) can be mentioned. Each of these degrees of familiarity with the language, past experience, knowledge of surrounding technologies, and familiarity with related APIs are structured so that options are provided to indicate the state, and when the project manager chooses that choice, the system assigns the value previously assigned to that state to the item of the performance influencing pre-element of the project. For example, in IMS (Information Management System) made by IBM Co. which is a hierarchical database, there exist languages peculiar to data definition language and data manipulation language (DL/I (Data Manipulation Language of IMS) and assembler macro).

<Human Resources 3: Ability Distribution>

An “ability distribution” is also one of the performance influencing pre-elements. In order to ensure that the project is achieved, the ability of a participant in the project must exceed a predetermined value. The two-dimensional or three-dimensional value of this ability is the ability distribution of the project participant. The ability distribution can be valued in a plurality of dimensions such as the ability value of multiple skills for each participant, the ability distribution of a group composed of a plurality of participants, and the ability of an upper group included in a plurality of groups. For example, when there is a task of a project which is directed from upstream to downstream, if the ability of the upstream group is high but the ability of the stationed group is low, the balance of the whole project becomes bad. In this way, the ability distribution is important as the performance influencing pre-element since the ability distribution assumed beforehand gives large effect on the performance of the project.

<Human Resources 4: Expertise>

An “expertise” is a field of ability to perform a task as a professional required for the project participant. Depending on the purpose of the project, the expertise as the performance influencing pre-element differs. For example, when the purpose of the project is to construct a database on new patents in the Patent Office, background knowledge is very important in constructing the database. For example, knowledge on legal deadline for patents, knowledge on the procedure for patents, knowledge on the patent law, knowledge on patent classification, knowledge on the technical field and so on are required. The expertise of these knowledge is required as the performance influencing pre-element. For example, with regard to the expertise of a project participant, if the project participant has expert knowledge of the legal deadline for patents and expert knowledge of patent classification, but does not have the knowledge of procedures, the patent law, or the technical field, the system may be configured so that 1×2 is associated with the participant because, for example, the project participant has two expertise. These systems are constructed so that the project manager selects an alternative from the alternatives depending on each participant, and the system associates a score with the participant according to the selection. Whether the expertise necessary for the performance of the project is sufficiently satisfied or not is scored according to the item of the expertise and is maintained.

<Human Resources 5: Resistance>

A“resistance” is, for example, a power to carry out the task without being discouraged when the task of the project is difficult to carry out due to the failure, and it can be called an injury resistance in other words. The injury resistance is to make the project participant receives what is called psychological test, and the result is scored. An optimum value is obtained from the accumulation of success cases and failure cases of past projects. The success probability of the project is influenced by whether the performance influencing pre-element is above or below the optimum value. Concretely, questions on “character characteristics”, “action characteristics”. “negative characteristics”, “stress resistance” and the like are output to each project participant (including the prospective participant. The same are applied throughout the specification) by the system or a peripheral device of the system, and the scoring of the response is performed. The scored value and the optimal value are compared with each other and used to calculate the success probability of the project.

<Human Resources 6: Reliability and Validity>

A “reliability and validity” is a reliability of project participant for project performance and a validity of assigning a task of the project. The reliability is calculated according to the history of the performance of the participant in the past. It is calculated using a rule that calculates reliability using past results as input. This may be configured to be calculated by Artificial Intelligence (AI). And, the validity is also calculated by using the task processing results of the participants of the past project by digitizing the attributes of human for multiple items. For example, assuming that a project participant has a value of 40 years old, 8/10 and 4 with respect to attributes such as “age”, “ability to design system concept”, and “the number of participants in SQL server-related projects”, the success probability is calculated using the performance influencing pre-element according to how many points are obtained as the validity by a person who has the same kind of attributes in a past project of the same kind as the project. For example, in the past project of the same kind as the project, if a participant with the same kind of attributes has been given 9/10 points for validity, the system will give the participant 9/10 points for validity as the performance influencing pre-element.

<Human Resources 7: Inputable Labor Costs>

An “inputable labor cost” is obtained by the system by comparing a labor cost of the current project with a labor cost that has been appropriately input in the appropriate personnel based on past results for project of similar scale. For example, for a similar project in the past, an appropriate labor cost for the case where similar human resources were invested is held, and by inputting the labor cost of the present project, the labor cost of the present project and the labor cost of the past project are compared with each other and the value as the performance influencing pre-element is acquired. For example, if the optimum input value of labor cost is 2 billion yen in the past case where same type and same scale human resource are input, and if the input labor cost of this time is 2.1 billion yen, the comparison result becomes 10/10.

<Human Resources 8: Supply-and-Demand Condition of Human Resources Market of Predetermined Ability>

A “supply-and-demand condition of the human resources market of the predetermined ability” is an item on how much probability the human resources necessary for the project can be employed, and it is a value given to the probability that the human resources can be gathered from the human resources market at the beginning of the project, in the middle of the project, after the end of the project, etc. The supply-and-demand condition of the human resources market is a concept including a present condition and a future condition. For example, the electronics industry tends to decline, and the possibility of abundant outflow of the human resources from such industry field by restructuring in the near future and distribution of the human resources in the market is digitized. The correlation between the past supply-and-demand condition of human resources and the past results of the project is maintained as a function, and the value of the performance influencing pre-element of the project can be obtained by inputting the present and future estimated supply-and-demand data of the human resources into the function.

<Human Resources 9: The Quality and Quantity of Personal Connections that Influence the Project>

A “quality and quantity of personal connections that influence the project” holds a correlation between the case of success and failure of the past project and the quality and quantity of personal connections, as a function. By inputting the numerical values of the quality and quantity of the personal connections of the present project into the function, the value of the performance influencing pre-element which influences the success probability of the project can be obtained. Concretely, the officer in charge of the project, the officer in the senior position, and the person with the approval authority such as president and vice president can be grasped as the representative personal connections which influence the project. In addition, the personal connections which influence the project include a supervisor of the engineer, a star engineer who possesses the key technology, an officer in charge of accounting, a manager of the personnel department, a manager of the personnel department who can control the personnel affairs of the employee concerning the project, a key person of the consulting firm which supports the project from the outside, a key person of the think tank which supports the management of the company, and so on. The quality and quantity can include the perspective of whether each person in these personal connections is friendly, hostile, or neutral toward the project, the perspective of whether the person is positive or negative toward the position, the past performance of the person, the attitude toward the past project, the friendly and hostile relationship between respective persons included in the personal connections and a degree of the friendly and hostile relationship, and so on. By quantifying these discretely and processing them in a computer, it is possible to obtain the value of the performance influencing pre-element and to quantify the influence on the project.

<Inputable Capital>

Inputable capital is an amount of capital that can be input in the project. The most representative inputtable capital is money. In addition, facilities, devices, systems, programs, and the like may be included as the inputable capital. Alternatively, facilities, devices, systems, programs, and the like may be converted into monetary units and processed as the inputable capital.

<Inputable Capital 1: Inputable Capital Amount>

An inputable capital amount is basically money. Money is consumed by the project, but the probability of success varies depending on whether there is a sufficient amount of money to accomplish the project, or only a just amount of money, or only a high probability that there will be a shortage of money. The inputable capital amount is a representative one of the performance influencing pre-element. In order to evaluate the inputable capital amount, it is possible to evaluate the inputable capital amount by acquiring capital amount assumed to be necessary for the project and comparing the inputable capital amount with the assumed required capital amount. This evaluation value will be processed later as the performance influencing pre-element.

<Inputable Capital 2: Additional Inputable Capital Amount (Due to Scope for Strategic Change of the Project)>

An additional inputable capital amount is a capital amount which is prepared for the situation such as the change of the project, though there is no necessity in the prior project plan, for the capital amount which is known to be consumed in the project in advance as the inputable capital amount. In principle, an additional input capital amount required in response to a goal and a problem of the project, and change of the task in the past comparable project is acquired in a monetary unit, and the performance influencing pre-element is evaluated by how much additional inputable capital amount exists as a reserve before the start of the project for the capital amount with the result of the additional input. For example, when an average value of additional input capital amount for the past project of the same scale and the same quality is A and the additional inputable capital amount for the project of this time is B, a value of B/A can be acquired as the performance influencing pre-element.

<Inputable Capital 3: Future Prediction of Exchange Rates when the Inputable Capital is Denominated in Foreign Currency>

When the inputable capital and the additional inputable capital are prepared in foreign currency, the inputable capital amount in the project home country is affected based on the future prediction of the exchange rate, so it is necessary to acquire the influence as the performance influencing pre-element. In many cases, the future exchange rate is estimated by the center line of exchange rate fluctuation and prediction volatility (range of dispersion) from the center line. In the embodiment, the predicted volatility can be replaced with a random variable and acquired as one element of the performance influencing pre-element. And, since the exchange rate changes over time, it is considered that the timing in which the inputable capital is actually input is assumed from the project plan, the performance influencing pre-element at each timing is acquired, and the value at each timing is averaged to be the performance influencing pre-element.

<Inputable Capital 4: Securing Status of Sources of Inputable Capital (Credit Line, Intention to Invest, Possibility of Issuance of Corporate Bonds in Some Cases)>

When the inputable capital is already secured in cash, the value of 1 can be given as the performance influencing pre-element, but when it is not secured in cash, it is necessary to acquire the risk of cashing as the performance influencing pre-element. This is a value of the probability. For example, in the case of financing from a financial institution, if the financial institution is a 0 risk financial institution, the interest rate at the time of the financing and the timing of the cash financing and the like become the performance influencing pre-element. However, when the credit line and the interest rate are assured in advance, the probability as the performance influencing pre-element becomes 1. When the inputtable capital is raised through investment from investor, it is necessary to acquire the risk of the investor or investment institution as the performance influencing pre-element. In addition, when it is planned to cover this by the issuance of corporate bonds, it is configured so that the total of the issuance amount of corporate bonds, securing status of the underwriters, economic risk of the underwriters, etc. is acquired as the performance influencing pre-element.

<Inputable Capital 5: Room for Stock Capital Increase to Raise Input Capital and Securing Status of New Stock Underwriters>

When the inputable capital is made by initial public offering of stocks or subscription of new stocks, etc., the assumed scale of these and in the case of public offering, the prediction of selling price, etc. are compared with past results. The same applies to the underwriting of new shares. When the past performance is compared with the present schedule and the past performance is risk A and the present schedule is risk B, the probability of success at present time can be acquired by the value B/A. This is the value which needs to be acquired as the performance influencing pre-element.

<Procurement of Materials>

Certainty of procurement of necessary materials, etc. becomes an element which greatly affects the project. In recent years, there have been cases in which the performance of projects was greatly affected by the embargo imposed by the United States on China and the political influence that obliged it to the countries of the world. For example, Chinese smartphone manufacturers became difficult to procure parts for smartphones, or they were forced to use their own OS because the OS (Operating System) of smartphones was not provided by the United States.

<Procurement of Materials 1: Situation of Securing Possibility of Necessary Materials>

The situation of securing possibility of necessary materials can be acquired as a value of probability of occurrence of the above-mentioned situation. For example, when political friction becomes more intense than usual and a trade war becomes more likely, the securing possibility of necessary materials falls below the probability of 1. It is preferable that these values can be calculated as probability values by giving values such as political situation, war situation, possibility of disaster, degree of epidemic and possibility of epidemic to a predetermined function based on information from economists, consultants, think tanks, etc.

<Procurement of Materials 2: Future Prediction of Procurement Costs of Necessary Materials>

Future prediction of the procurement cost of necessary materials is also important. For example, there are cases in which a trade war occurred and tariffs were imposed more than twice as much as before. In this case, the procurement cost of necessary materials exceeds the usual expectation, and it gives a bad influence on the project success as the performance influencing pre-element. When the maximum value of the success probability is set to 1, a value in which the success probability becomes a value smaller than 1 according to the predicted rate of increase in the procurement cost is acquired as the performance influencing pre-element based on the future prediction of the procurement cost of necessary materials.

<Procurement of Materials 3: Future Prediction of Securing Quality of Necessary Materials>

Failure to secure the future quality of the necessary materials will affect the success of the project. For example, if the project is trying to procure the necessary materials with a product yield of 99% and the prediction falls to 90%, the load on the project will increase, such as increasing the amount of materials procured, increasing the number of quality checkers, and so on. And, when the operation error rate of the server to be used for the system becomes lower than the prediction, the redundant system must be constructed excessively to compensate for the error, which causes the load to the performance of the project. Since the success probability of the project is affected by these factors, it is necessary to acquire them numerically as the performance influencing pre-element.

<Procurement of Materials 4: Others>

In addition, “future prediction of storage cost of necessary materials”, “future prediction of transportation cost of necessary materials”, and “future prediction of processing cost of necessary materials” are elements which affect the success probability of the project, and it may be necessary to treat them as the performance influencing pre-elements by digitizing them.

<Information Resource>

Information resource is the height of information processing ability, if it is widely expressed. This can be grasped as discovery, collection, development (research ability) and so on. These elements can also be digitized using a predetermined function as in the prior example and acquired as elements that influence the success probability of the project (specifically, performance influencing pre-element).

<Information Resource 1: Ability to Find Information that Contributes to Solutions when Problems Occur>

This is an expression from the viewpoint of the whole project, but from the microscopic viewpoint, it is comprised of the ability of participants who participate in the project. It is preferable that the project participants have a project participant database in which the history of past projects is stored, and in the database, various abilities of the project participants are evaluated on a scale of, for example, 10 points. Then, the evaluation is given from the viewpoint of whether the participant leads the task and the management to success, in the task and management in charge of the participant. Based on such a database, it is configured so that the ability to find information which contributes to the solution when the problem occurs can be acquired as a value based on the ability of each participant of this project and the similarity with the task of which the participant is in charge.

<Information Resource 2: Others>

In addition, values of “ability to collect information necessary for the performance of the project”, “ability to collect information necessary for change of tasks of the project”, and “research ability for solution of problems necessary for the performance of the project” are acquired by using the same mechanism and database as above.

The question unit 0102 has a function to output a question for associating a performance pre-state value with the performance influencing pre-element assuming a specific project in which the project is specifically specified and prompt an input, wherein the performance pre-status value is one or more of a numerical value which is a value of the specific project, presence or absence, YES or NO, a level, and an option. Finally, these values are treated as numerical values because they are substituted into the variable part of the probability distribution derivation function and used to calculate the success probability distribution. It is also possible to ask a question in which the subject writes a sentence freely. Free-form answers can be scored by artificial intelligence, etc., and finally treated as numbers as well.

It should be noted that a value for the answer of the question part 0102, i.e., a performance pre-state value must be appropriately set according to the form of the probability distribution derivation function. The value is determined by appropriately estimating the influence of the probability distribution derivation function on the derived success probability distribution. This can be set based on the empirical rule of a plurality of past projects. For example, in response to the question of how much is the inputable capital, even if the same amount of 500 million yen is used for two different projects, the value may be 100 (%: a numerical value representing the degree of satisfaction) for Project A and 80 (%: a numerical value representing the degree of satisfaction) for Project B if the used probability distribution derivation functions differ from each other.

It is preferable that a party to which the question unit 0102 prompts input differs depending on the role of the project. For example, the question about human resources is a person who decides the personnel affairs of the project beforehand, and the question about capital resources is a person who makes the financing plan of the project beforehand.

The question unit 0102 can be configured so that the question is output from the terminal of each project participant, and can be configured so that the question prepared in advance is output according to the identification information of the project participant input to the terminal. Further, the question unit 0102 can be configured to omit questions of overlapping characteristics among questions for the same person in the past projects. For example, the questions to be omitted are sex, age, family structure, and place of residence. It is preferable that the performance influencing pre-element or a value associated with the performance influencing pre-element identification information is stored by the question unit 0102. It is preferable that the stored information is associated with the attribute of the project acquired from the answer of the question unit 0102. It is preferable that the answer is associated with the person who gave the answer and the role of the person in the project.

Moreover, it is preferable that these values stored in association with each past project are associated with performance progress information and final conclusion information of the project. Then, it is preferable that the weighting of each value of the probability distribution derivation function and the handling of the value in the probability distribution derivation function are corrected by comparing the success probability predicted in advance with the actual success degree. This can be realized by deep learning using artificial intelligence.

The following are examples of questions for each performance influencing pre-element.

<Question about Human Resources>

(1) How many inputable persons are there per unit scale of the project (the scale is obtained by input capital, project duration, etc.)?
(2) What is the average number of tasks per participant in the project?
(3) What is the ability value of each participant in the project (i.e., a person who scores his/her abilities in some form) in the equivalent project?
(4) How much is the inputable labor cost?
(5) How is the ability distribution of project participant per task distributed?
(6) How many professionals are qualified?
(7) What is the supply-and-demand condition of the human resources market for a given ability, with a deviation of 50 when there is sufficient supply capacity?

<Question about Inputable Capital>

(1) How much is the inputable capital amount in yen?
(2) How much is the additional inputable capital amount (due to the scope for strategic change of the project) in yen?
(3) If the inputable capital is denominated in foreign currency, what percentage range is the future prediction of the exchange rate relative to the average of the past five years? How would this be represented by Bollinger Band? (“Bollinger band” is an index based on the idea of standard deviation and normal distribution of statistics, which determines how much the price of a certain period deviates from the average value of the period and how dispersed it is. For example, it shows to what extent the closing price of dollar/yen for 5 days varies.)
(4) Securing status of sources of inputable capital (credit line, intention to invest, possibility of issuing corporate bonds in some cases)
(5) What is the rating for the scope for share capital increase to raise capital and the securing status of new stock underwriters? For example, a rating of Standard & Poor's is input as a value.

<Question Regarding Procurement of Materials>

(1) Enter the securing status of the necessary materials as a value between 0% and 100%.
(2) Enter the future prediction of the procurement cost of the necessary materials as a deviation value against the average for the past five years. Alternatively, enter a value based on a 5-year average value of 50.
(3) Enter the future prediction of the quality assurance of the necessary materials as a deviation value against the average for the past five years. Alternatively, enter a value based on a 5-year average value of 50.
(4) Enter the future prediction of the storage cost of the necessary materials as a deviation value against the average of the past five years. Alternatively, enter a value based on a 5-year average value of 50.
(5) Enter the future prediction of the transportation cost of the necessary materials as a deviation value against the average for the past five years. Alternatively, enter a value based on a 5-year average value of 50.
(6) Enter the future prediction of the processing cost of the necessary materials as a deviation value against the average for the past five years. Alternatively, enter a value based on a 5-year average value of 50.

<Questions Regarding Information Resources>

(1) Enter an ability to find information that contributes to solving a problem when the problem occurs as a deviation value against the average finding ability for the past five years. Alternatively, enter a value based on a 5-year average value of 50.
(2) Ability to gather information necessary for the performance of the project.
Ability to collect necessary information at the time of changing tasks and the like of the project.
Research ability to resolve issues necessary for the performance of the project.

### Embodiment 1: Probability Distribution Derivation Function Holding Unit

The probability distribution derivation function holding unit 0103 has a function of holding a probability distribution derivation function which is a function for deriving the probability distribution of the success of the project using the performance pre-status value associated with the performance influencing pre-element.

The probability distribution derivation function is, for example, a function for deriving a success probability distribution function in which the horizontal axis is the success probability of the project and the vertical axis is the frequency of success of the project with the probability, and is a function in which the success probability distribution function derived by the performance pre-status value which is the value of the performance pre-element is varied. In other words, the probability distribution derivation function is a function in which the success probability distribution function is determined when the performance pre-status value is determined. In other words, it is a function of the function. The derived success probability distribution function is most typically a normal distribution function whose frequency is equally distributed in right and left with the mean success probability as the center, or a function distributed in a shape close to the normal distribution function. In the case of a normal distribution function or close to a normal distribution function, a variance σ² (square of σ) and a mean μ are determined by the performance pre-status value. That is to say, a function in which the variance σ² (square of σ) and the mean μ are functions of the performance pre-status value is the probability distribution derivation function.

However, the degree of dispersion of the normal distribution and the degree of distortion from the normal distribution close to the normal distribution are changed by the form of the function of dispersion σ^{r} (square of σ) which is the probability distribution derivation function and the form of the function of average μ which is also the probability distribution derivation function. That is to say, the probability distribution derivation function is a function which is decided according to the property of the project and the attribute of the project executor. When the form of the probability distribution derivation function, i.e., the function of the variance σ² (square of σ) and the mean μ is specified, the variance σ² (square of σ) and the mean μ are determined by substituting the performance pre-status value into the function. When the variance σ² (square of σ) and the mean μ are determined, the normal distribution function is determined, and the success probability distribution is specified.

For example, if there are 100 performance influencing pre-elements and one performance pre-status value is associated with each of them, the success probability distribution of the project can be obtained by substituting the performance pre-status value associated with the performance influencing pre-element into each of 100 variables of the probability distribution derivation function.

The probability distribution is typically in the form of a normal distribution, but is not necessarily limited to a normal distribution and may be in other forms. For example, a distribution in which the normal distribution function (probability distribution derivation function) determined by the variance σ² (square of σ) and the mean μ is modified by a function F(x) can be considered. This F (x) is called a modified function. The modified function is also a probability distribution derivation function. F(x) is also a function determined by the performance pre-state values given to one or more performance influencing pre-elements. In this case, the distribution is expressed as fb (x)=F(x)×fa(x) as a product of the normal distribution fa(x) and the modified function F(x). This representation is the probability distribution function to be finally obtained and the success probability distribution. It should be noted that the modified function is not necessarily related to the normal distribution function in the form of a product, but may be used to be added or subtracted as a constant term, or to be added or subtracted to x, or of course, the modified function may be used in the form of a mix of two or more of these functions. Further, the modified function is not limited to one type, and a plurality of modified functions may be used. These corrections may be appropriately corrected by machine learning of artificial intelligence (e.g., deep learning), or may be appropriately corrected by a combination of machine learning and a known statistical technique (e.g., Bayesian statistics).

For example, in the case of Bayesian statistics. P (A|B) can be defined by the following calculation formula. P (A|B) represents the a posteriori probability. The posteriori probability is a probability that an event A will occur under the condition that an event B will occur.

P(A|B)=P(B|A)P(A)/P(B) <Calculation formula>

Where P (A) represents the prior probability. The prior probability is a probability that the event A occurs before the event B occurs. The prior probability can be set subjectively by the user of this system. P(B|A) represents a likelihood. The likelihood is a probability that the event B will occur under the condition that the event A will occur (or if the event A is assumed to be true). P(B) represents a marginal likelihood. The marginal likelihood is a probability that the event B will occur before the event A. That is, the marginal likelihood is a probability that the event B becomes true among all events A and B. For example, information such as that the project does not reach the target can be adopted as the event A. and information such as that the project scale is large or that the experience value of the project manager is low can be adopted as the event B. According to Bayesian statistics, the probability of the event A can be changed based on the event B.

As described above, while it is difficult to correctly predict the success probability. Bayesian statistics that can be predicted while changing the argument (parameter) representing the correct answer from the performance pre-status value given to the performance influencing pre-element is compatible with the machine learning. Thus, using a combination of the machine learning and Bayesian statistics is more useful for predicting the success probability than using the machine learning alone.

It can also be configured to correct the probability distribution derivation function by feedback of the probability distribution derivation function and deep learning of artificial intelligence, etc., not to correct the probability distribution derivation function used initially when the project is completely finished, but to correct the probability distribution derivation function by feedback of the performance progress of the project in the middle according to the progress of the project.

For example, since the value associated with the performance influencing pre-element may change over time, and there may be already determined performance influencing pre-element, at least for the already determined performance influencing pre-element, the value selected and acquired by the question unit is compared with the actual value, and the probability distribution derivation function may be modified.

<Success Probability Distribution Calculating Unit>

The success probability distribution calculating unit 0104 has a function of calculating the success probability distribution of the project for which input is received at the question unit 0102 by using the performance pre-state value associated with each performance influencing pre-element (performance influencing pre-element identification information) obtained by input to the question unit 0102 and the probability distribution derivation function held in the probability distribution derivation function holding unit 0103. The success probability distribution is typically the normal distribution, but is not limited to this as described above. Further, as described above, calculating the success probability distribution using the performance influencing pre-element is not limited before the start of the project, and it is preferable to calculate the success probability distribution while increasing the accuracy of the value of the performance influencing pre-element at any time during the performance of the project. For this purpose, it is preferable that the question unit 0102 has a schedule for outputting re-questions according to the progress of the project, and is configured so that in the intermediate process of the project, an appropriate project participant is selected as necessary, the question is output from the terminal, the value of the performance influencing pre-element is corrected, and the success probability distribution with higher accuracy is calculated and presented. In addition, it is preferable that a probability that the success probability described later can be set to a certain value or more is calculated similarly at the intermediate stage of the project, and the advice for further improving the success probability is continuously output even during the performance of the project.

<Success Probability Distribution Holding Unit>

The success probability distribution holding unit 0105 has a function of holding the calculated success probability distribution. Although the success probability distribution is calculated before the start of the project, it is preferable to calculate the success probability distribution repeatedly during the performance of the project according to the schedule of the question unit and to hold the success probability distribution of the same project in time series, because the success probability distribution with higher accuracy can be obtained by using the value of the performance influencing pre-element already determined as described above or by using the value of the performance influencing pre-element with higher accuracy as time passes. That is to say, it is configured to have a success probability distribution history holding means.

<First Embodiment: Hardware Configuration>

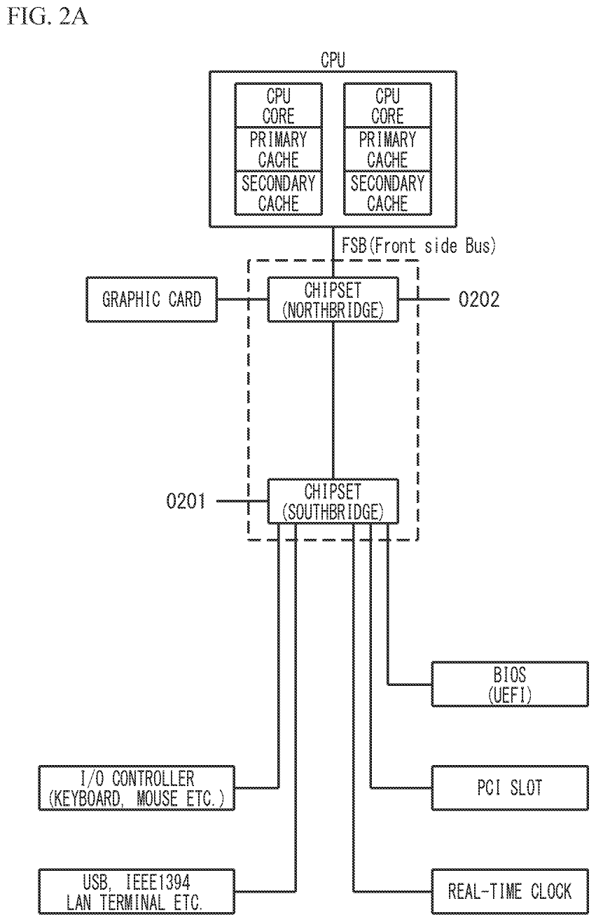

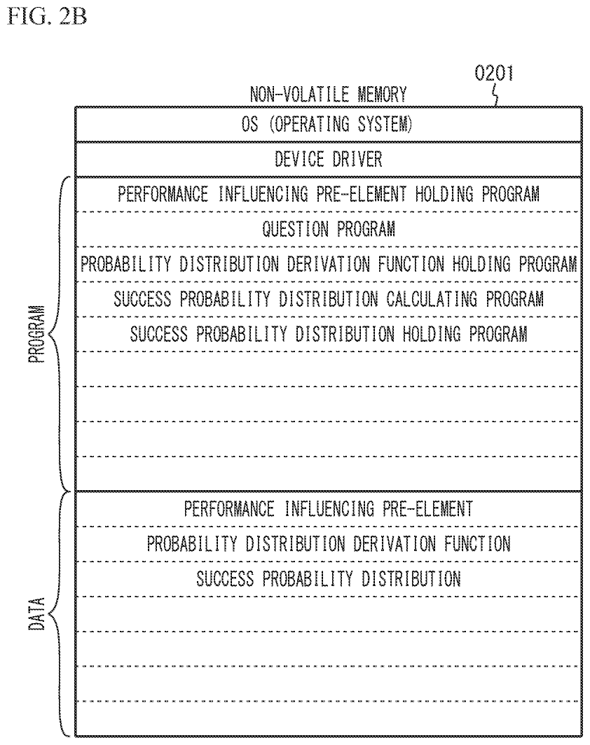

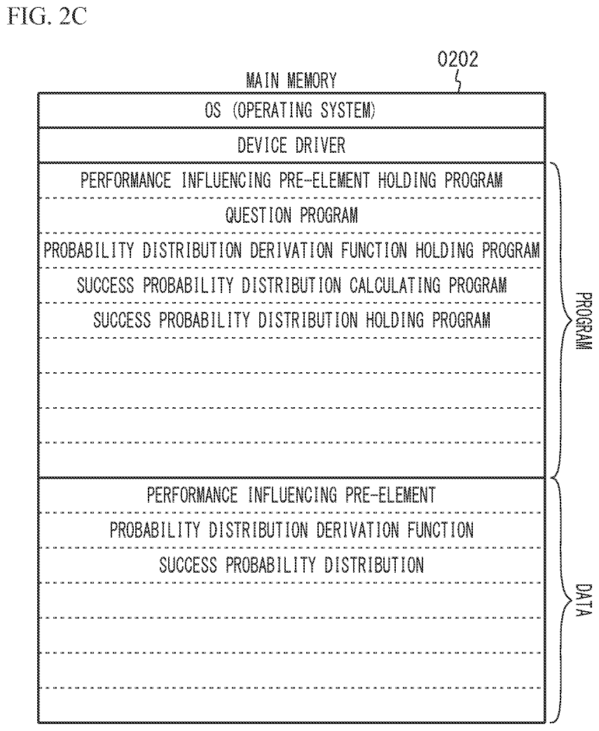

FIGS. 2A to 2C are diagrams illustrating an example of the hardware configuration in the present embodiment. The hardware configuration of the project success probability calculation system 0100 according to the present embodiment will be described with reference to the drawings.

As illustrated in FIGS. 2A to 2C, a computer includes a chipset, a CPU, anon-volatile memory, a main memory, various buses, a BIOS (Basic Input Output System), various interfaces, a real-time clock, and the like, which are configured on a motherboard. These work in conjunction with an operating system, device drivers, various programs, and so on. The various programs and various data constituting the present disclosure are configured to efficiently utilize these hardware resources to execute various processes.

<Chipset>

A “chipset” is a set of large-scale integrated circuits (LSIs: Large Scale Integration) that are mounted on the motherboard of the computer and integrate a communication function (that is, a bridge function) between an external bus of the CPU and a standard bus that connects the memory and the peripheral devices. There are cases where a two-chipset configuration is adopted and cases where a one-chipset configuration is adopted. A north bridge is provided on a position near the CPU and the main memory, and a south bridge is provided on a position near the interface with a relatively low-speed external I/O and far from the CPU and the main memory.

(North Bridge)

The north bridge includes a CPU interface, a memory controller, and a graphic interface. The CPU may be responsible for most of the functions of the conventional north bridge. The north bridge is connected to a memory slot of the main memory via a memory bus, and is connected to a graphic card slot of a graphic card by a high-speed graphic bus (AGP (Accelerated Graphics Port), PCI (Peripheral Component Interconnect) Express).

(South Bridge)

The South Bridge is connected to a PCI interface (PCI slot) via a PCI bus, and is responsible for I/O functions and sound functions with an ATA (Advanced Technology Attachment)(SATA (Serial ATA)) interface, a USB interface, an Ethernet (registered trademark) interface, and the like. Incorporating circuits that support a PS/2 port, a floppy disk drive, a serial port, a parallel port, and an ISA (Industry Standard Architecture) bus that do not require or cannot require high-speed operation will hinder the speeding up of the chipset itself. Therefore, they may be separated from the chip of the south bridge and assigned to another LSI called a super I/O chip. The buses are used to connect the CPU (MPU: Micro Processor Unit) to the peripheral devices and the various control units. The buses are connected to the chipset. A memory bus used for connection with the main memory may adopt a channel structure instead of the memory bus in order to increase the speed. As the bus, a serial bus or a parallel bus can be adopted. While the serial bus transfers data bit by bit, the parallel bus collects the original data itself or multiple bits cut out from the original data as a group and transmits them at the same time through multiple communication paths. A dedicated clock signal line is provided in parallel with the data line to synchronize data demodulation on the receiving side. It is also used as a bus that connects a CPU (chipset) and an external device, and includes GPIB (General Purpose Interface Bus), IDE (Integrated Drive Electronics)/(parallel) ATA, SCSI (Small Computer System Interface), and PCI. Since there is a limit to the speedup, the data line may be the serial bus in the improved PCI Express of PCI or the improved serial ATA of parallel ATA.

<CPU>

The CPU reads, interprets, and executes instruction sequences called programs in the main memory in order, and outputs information consisting of signals to the main memory. The CPU functions as a center portion for performing calculation within the computer. The CPU is composed of a CPU core part that mainly preform the calculation and a peripheral part thereof. A register, a cache memory, an internal bus connecting the cache memory and the CPU core, a DMA (Direct Memory Access) controller, a timer, an interface with the connection bus with the north bridge, and the like are included inside the CPU. A plurality of CPU cores may be provided in one CPU (chip). Further, in addition to the CPU, a process may be performed by a graphic interface (GPU (Graphics Processing Unit)) or an FPU (Floating Point Unit).

<Non-Volatile Memory>

### (HDD (Hard Disk Drive))

The basic structure of a hard disk drive as the non-volatile memory consists of a magnetic disk, a magnetic head, and an arm on which the magnetic head is mounted. An external interface can adopt SATA (ATA in the past). A high-performance controller supports communication between hard disk drives, using SCSI, for example. For example, when copying a file to another hard disk drive, the controller can read the sector and transfer and write it to another hard disk drive. At this time, the memory of the host CPU is not accessed. Therefore, it is not necessary to increase the load on the CPU.

<Main Memory>

The CPU directly accesses the main memory and executes various programs on the main memory. The main memory is a volatile memory, and DRAM is used.

The program on the main memory is developed from the non-volatile memory onto the main memory in response to a start command of the program. After that, the CPU executes the program according to various execution instructions and execution procedures in the program.

<Operating System (OS)>

The operating system is used to manage the resources on the computer for the application to use, to manage various device drivers, and to manage the computer itself which is the hardware. Small computers may use a firmware as the operating system.

<BIOS>

The BIOS causes the CPU to perform procedures for booting the computer hardware and running the operating system, and is most typically the hardware that the CPU first reads when it receives a boot command of the computer. An address of the operating system stored in the disk (non-volatile memory) is described in the BIOS, the operating system is sequentially developed to the main memory by the BIOS developed in the CPU, and the computer puts into an operating state. The BIOS also has a check function for checking the presence or absence of various devices connected to the bus. The result of the check is saved in the main memory and made available by the operating system as appropriate. The BIOS may be configured to check the external device or the like.

The above configuration is the same for other embodiments.

As illustrated in FIGS. 2A to 2C, the present system can basically be configured by a general-purpose computer program and various devices. In the operation of the computer, the program recorded in the non-volatile memory is basically loaded into the main memory, and the main memory, the CPU, and various devices execute the process. The communication with the device is done via the interface connected to the bus line. The interface may be a display interface, a keyboard, a communication buffer, or the like.

As illustrated in FIGS. 2A to 2C, the non-volatile memory stores various programs called PROEVER. The non-volatile memory includes a “performance influencing pre-element holding program” configured to hold a performance influencing pre-element which is a pre-element that influences the performance of a project and is empirically known to influence the success of the project; a “question program” configured to output a question for associating a performance pre-status value with the performance influencing pre-element assuming a specific project in which the project is specifically specified and prompt an input, wherein the performance pre-status value is one or more of a numerical value which is a value of the specific project, presence or absence, YES or NO, a level, and an option; a “probability distribution derivation function holding program” configured to hold a probability distribution derivation function which is a function for calculating a probability distribution of success of the specific project using the performance pre-status value associated with the performance influencing pre-element; a “success probability distribution calculating program” configured to calculate a success probability distribution of the specific project receiving the input by the question unit 0102, based on the performance pre-status value associated with the performance influencing pre-element obtained by the input to the question unit 0102 and the probability distribution derivation function held in the probability distribution derivation function holding unit 0103; and a “success probability distribution holding program” configured to hold the calculated success probability distribution. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

<First Embodiment: Flow of Process>

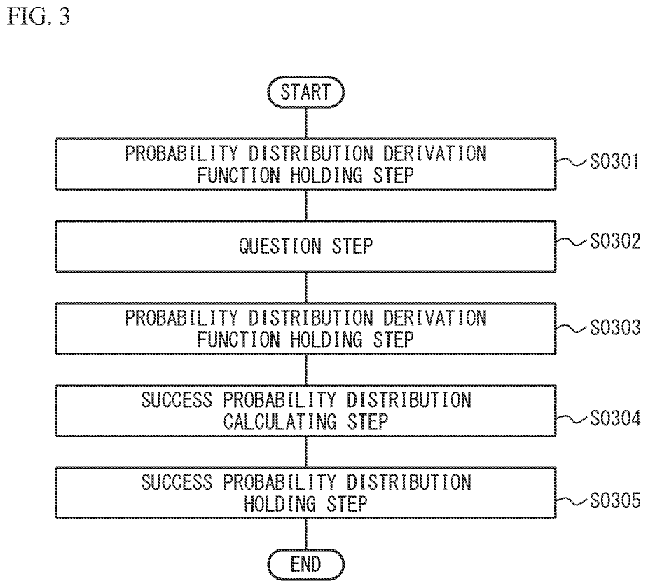

FIG. 3 is a flowchart illustrating the process w % ben the project success probability calculation system 0100 according to the first embodiment is used. The flow of process of this embodiment is an operation method of the project success probability calculation system 0100 which is a computer having a performance influencing pre-element holding step S0301, a question step S0302, a probability distribution derivation function holding step S0303, a success probability distribution calculating step S0304, and a success probability distribution holding step S0305. Hereinafter, each step will be described below.

The performance influencing pre-element holding step S0301 holds a performance influencing pre-element which is a pre-element that influences the performance of a project and is empirically known to influence the success of the project.

The question step S0302 outputs a question for associating a performance pre-status value with the performance influencing pre-element assuming a specific project in which the project is specifically specified and prompt an input. The performance pre-status value is one or more of a numerical value which is a value of the specific project, presence or absence, YES or NO, a level, and an option.

The probability distribution derivation function holding step S0303 holds a probability distribution derivation function which is a function for calculating a probability distribution of success of the specific project using the performance pre-status value associated with the performance influencing pre-element.

The success probability distribution calculating step S0304 calculates a success probability distribution of the specific project receiving the input by the question unit 102, based on the performance pre-status value associated with the performance influencing pre-element obtained by the input to the question unit 0102 and the probability distribution derivation function held in the probability distribution derivation function holding unit 0103.

The success probability distribution holding step S0305 holds the calculated success probability distribution.

### Second Embodiment

<Second Embodiment; Summary>

In addition to the first embodiment described above, the second embodiment provides a project success probability calculation system having a function of acquiring desired success probability information which is information on a desired success probability and calculating a realization probability which is a probability of realizing the desired success probability based on the held success probability distribution and the acquired desired success probability information.

<Second Embodiment: Functional Configuration>

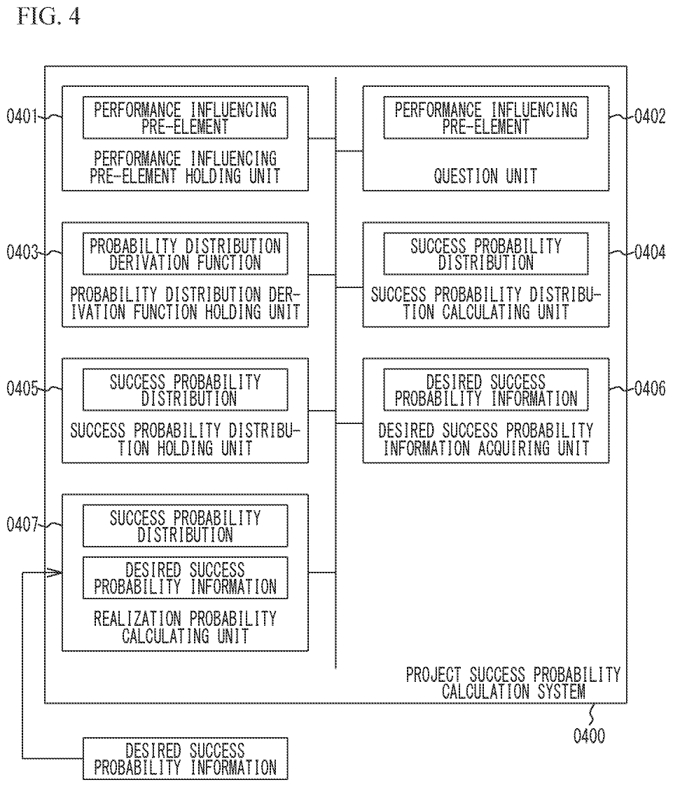

FIG. 4 is a diagram illustrating a functional configuration of a project success probability calculation system 0400 according to the second embodiment. The project success probability calculation system 0400 of the present embodiment has a performance influencing pre-element holding unit 0401, a question unit 0402, a probability distribution derivation function holding unit 0403, a success probability distribution calculating unit 0404, and a success probability distribution holding unit 0405. Further, the project success probability calculation system 0400 of the present embodiment has a desired success probability information acquiring unit 0406 and a realization probability calculating unit 0407.

<Second Embodiment: Desired Success Probability Information Acquiring Unit>

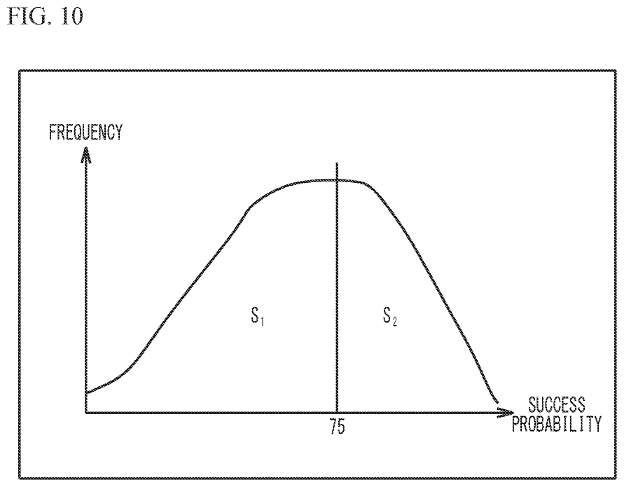

The desired success probability information acquiring unit 0406 is configured to acquire the desired success probability information which is information about the desired success probability. In the success probability distribution held in the first embodiment, the horizontal axis represents the success probability, and the vertical axis represents the frequency of realization of each success probability at each performance pre-status value given to the performance influencing pre-element of the project. On the assumption of the success probability distribution, a value which acquires that the success probability of the project is over a certain value is the desired success probability information. For example, in the case where it is desired that the success probability is 75% or more, “75%” or “75% or more” is the desired success probability information. Then, for example, as illustrated in FIG. 10, if a value obtained by collecting all frequencies of 75% or more is S1 and a value obtained by collecting all frequencies of values smaller than S2, the total frequency is S1+S2, so the realization probability, which is the probability of realizing the success of the project with the probability of 75% or more, is S2/(S1+S2).

<Second Embodiment: Realization Probability Calculating Unit>

The realization probability calculating unit 0407 calculates the realization probability which is the probability of realizing the desired success probability based on the held success probability distribution and the acquired desired success probability information. As described above, the realization probability is a value obtained by dividing the frequency of the probability greater than or equal to the desired success probability by all the probability frequency using the desired success probability and the success probability distribution indicated by the desired success probability information, and the realization probability calculating unit 0407 calculates the realization probability by performing this calculation.

The calculation result of the realization probability calculation unit 0407 is calculated according to the success probability distribution. Therefore, when the value of the performance influencing pre-element changes according to the progress of the project as described above, since the success probability distribution calculated by the probability distribution derivation function changes according to the value of which accuracy is improved, it is preferable that the realization probability is calculated again every time the success probability changes.

And, it is preferable to construct the system so that the calculation result of the realization probability may be associated with the progress information of the project and held in this system. Then, it is preferable to construct the system so as to output a chart illustrating the change of the realization probability in the order of characteristic and progress information of the project. In addition, even if the value of the performance influencing pre-element does not actually change according to the progress of the project, it is preferable to input one or more values of the performance influencing pre-element for virtual simulation, and to output how the realization probability changes according to the change of the value as a chart or graph. This is because the performance policy of the project can be decided through the chart or graph.

<Second Embodiment: Hardware Configuration>

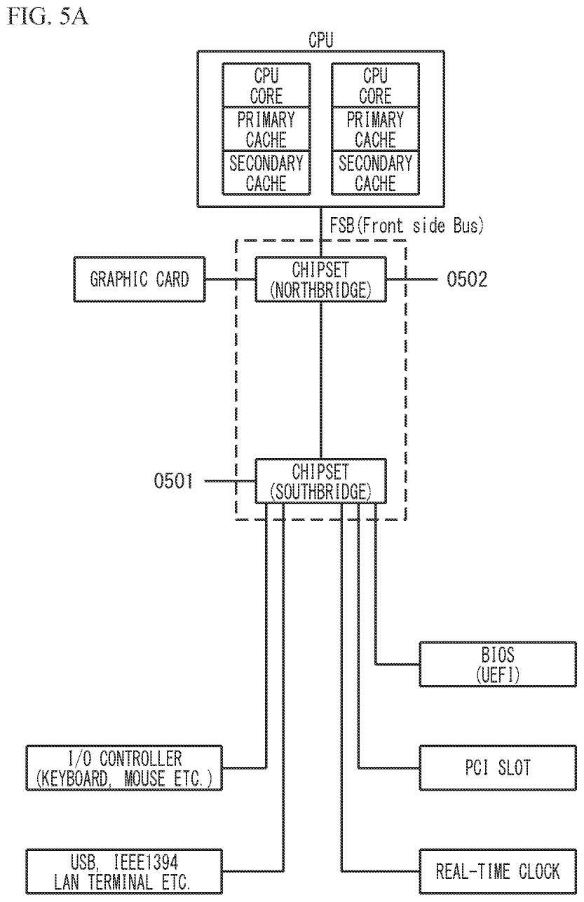

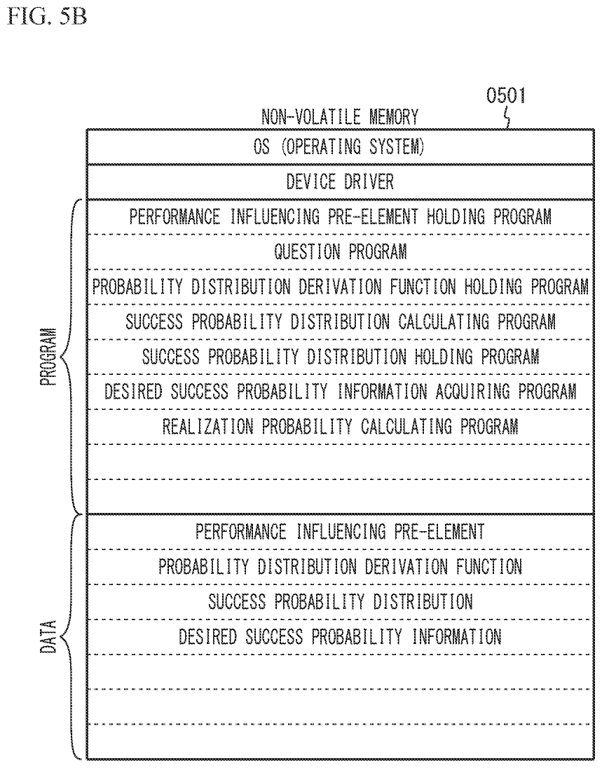

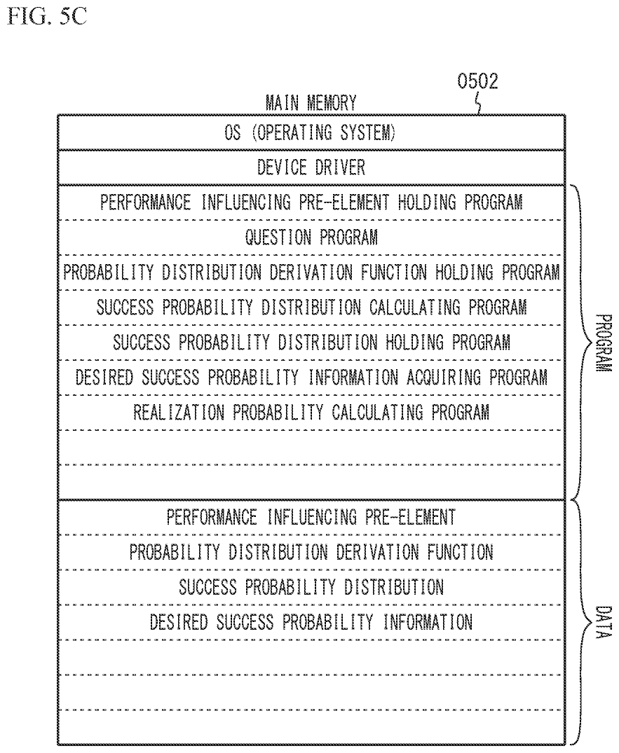

FIGS. 5A to 5C are diagrams illustrating a hardware configuration of the project success probability calculation system according to the second embodiment. As illustrated in FIGS. 5A to 5C, a computer includes a chipset, a CPU, a non-volatile memory, a main memory, various buses, a BIOS (Basic Input Output System), various interfaces, a real-time clock, and the like, which are configured on a motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 5A to 5C, the non-volatile memory includes a “performance influencing pre-element holding program” configured to hold a performance influencing pre-element which is a pre-element that influences the performance of a project and is empirically known to influence the success of the project; a “question program” configured to output a question for associating a performance pre-status value with the performance influencing pre-element assuming a specific project in which the project is specifically specified and prompt an input, wherein the performance pre-status value is one or more of a numerical value which is a value of the specific project, presence or absence. YES or NO, a level, and an option; a “probability distribution derivation function holding program” configured to hold a probability distribution derivation function which is a function for calculating a probability distribution of success of the specific project using the performance pre-status value associated with the performance influencing pre-element; a “success probability distribution calculating program” configured to calculate a success probability distribution of the specific project receiving the input by the question unit 0402, based on the performance pre-status value associated with the performance influencing pre-element obtained by the input to the question unit 0402 and the probability distribution derivation function held in the probability distribution derivation function holding unit 0403; a “success probability distribution holding program” configured to hold the calculated success probability distribution; a “desired success probability information acquiring program” configured to acquire desired success probability information which is information on a desired success probability; and a “realization probability calculating program” configured to calculate a realization probability which is a probability of realizing the desired success probability based on the held success probability distribution and the acquired desired success probability information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other. Further, although not illustrated in the figure, the non-volatile memory includes a “project diagnostician identification information acquiring program” configured to acquire diagnostician identification information for identifying a diagnostician who enters a diagnosis into a diagnosis sheet in order to associate the diagnostician identification information with a project diagnosis sheet.

<Second Embodiment: Flow of Process>

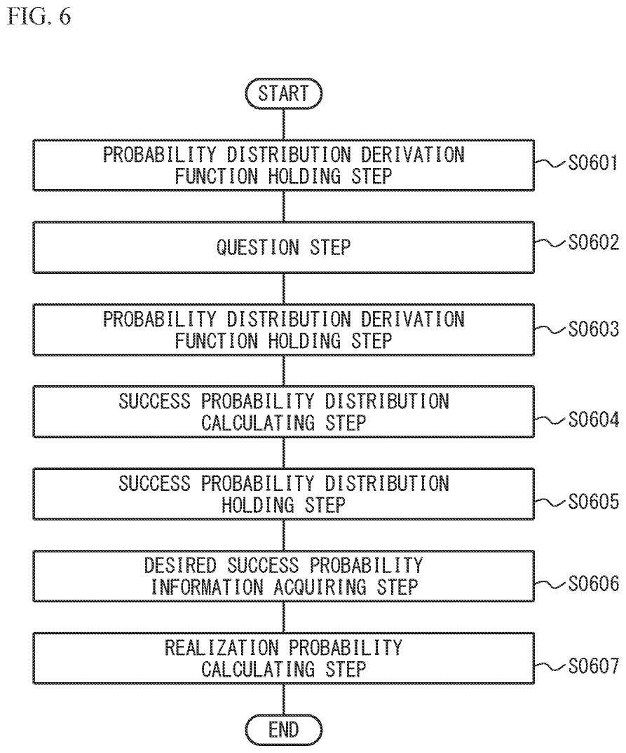

FIG. 6 is a flowchart illustrating a process when the project success probability calculation system according to the second embodiment is used. The flow of process of this embodiment includes a performance influencing pre-element holding step S0601 configured to hold a performance influencing pre-element which is a pre-element that influences the performance of a project and is empirically known to influence the success of the project; a question step S0602 configured to output a question for associating a performance pre-status value with the performance influencing pre-element assuming a specific project in which the project is specifically specified and prompt an input, wherein the performance pre-status value is one or more of a numerical value which is a value of the specific project, presence or absence, YES or NO, a level, and an option; a probability distribution derivation function holding step S0603 configured to hold a probability distribution derivation function which is a function for calculating a probability distribution of success of the specific project using the performance pre-status value associated with the performance influencing pre-element; a success probability distribution calculating step S0604 configured to calculate a success probability distribution of the specific project receiving the input by the question step S0602, based on the performance pre-status value associated with the performance influencing pre-element obtained by the input to the question step S0602 and the probability distribution derivation function held in the probability distribution derivation function holding step S0603; a success probability distribution holding step S0605 configured to hold the calculated success probability distribution; a desired success probability information acquiring step S0606 configured to acquire desired success probability information which is information on a desired success probability; and a realization probability calculating step S0607 configured to calculate a realization probability which is a probability of realizing the desired success probability based on the held success probability distribution and the acquired desired success probability information. The steps S0601 to S0605 except for the desired success probability information acquiring step S0606 and the realization probability calculating step S0607 are the same as those of the first embodiment.

The desired success probability information acquiring step S0606 acquires the desired success probability information which is information on the desired success probability.

The realization probability calculating step S0607 calculates the realization probability which is the probability of realizing the desired success probability based on the held success probability distribution and the acquired desired success probability information.

### Third Embodiment

<Third Embodiment; Summary>

A third embodiment is an embodiment based on the second embodiment and is configured to be able to acquire and output an advice for improving the realization probability illustrated in the second embodiment.

<Third Embodiment; Functional Configuration>

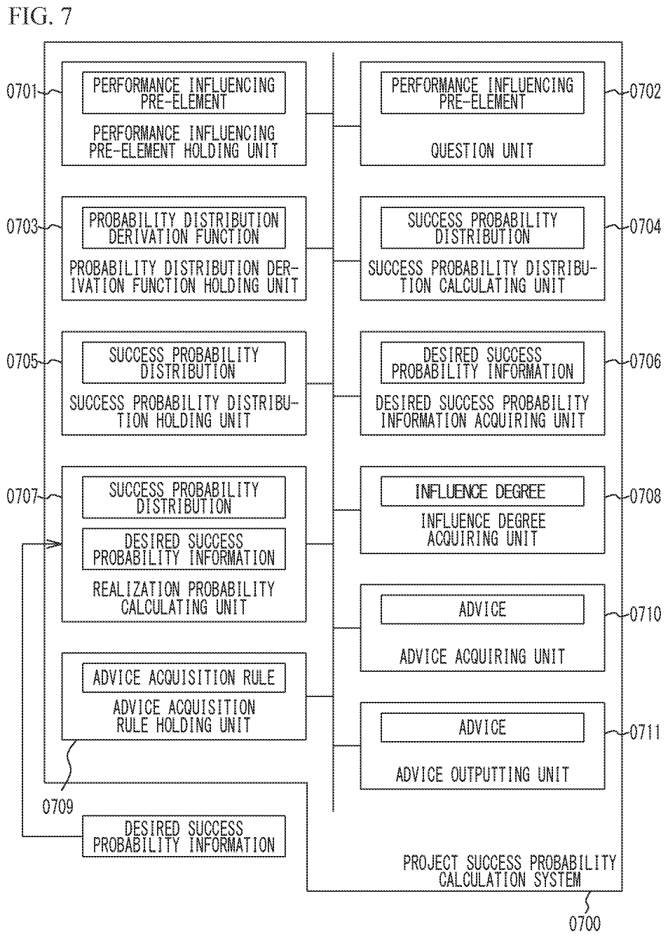

FIG. 7 is a diagram illustrating a functional configuration of a project success probability calculation system 0700 according to the third embodiment. The project success probability calculation system 0700 of the present embodiment has a performance influencing pre-element holding unit 0701, a question unit 0702, a probability distribution derivation function holding unit 0703, a success probability distribution calculating unit 0704, a success probability distribution holding unit 0705, a desired success probability information acquiring unit 0706 and a realization probability calculating unit 0707. The project success probability calculation system 0700 of the present embodiment is based on the configuration of the second embodiment and further includes an influence degree acquiring unit 0708, an advice acquisition rule holding unit 0709, an advice acquiring unit 0710, and an advice outputting unit 0711.

<Third Embodiment: Influence Degree Acquiring Unit>

The influence degree acquiring unit 0708 acquires an influence degree of the performance pre-status value associated with the performance influencing pre-element on the realization probability. The “influence degree” is synonymous with a “contribution rate”. The influence degree (increase or decrease) of the value of the performance influencing pre-element is expressed in composition ratio (%) when a growth rate (change rate) as the whole realization probability is 100. The concrete formula can be expressed as “contribution rate=increase/decrease of the value of the performance influencing pre-element (performance pre-state value)/increase/decrease of the overall realization probability (×100)”. Therefore, on the assumption of the acquired success probability distribution, when acquiring that the success probability of the project is more than a certain value, if in the success probability distribution diagram (FIG. 10), for example, the value obtained by collecting all frequencies of 75% or more is S1 and the value obtained by collecting all frequencies of less than S2 as mentioned above, the total frequency is S1+S2, so that the realization probability which is the probability of realizing the success of the project with a probability of 75% or more is S2/(S1+S2)=J %. This value can be defined as ΔA/ΔJ (×100) when the value of the performance influencing pre-element (performance pre-state value) is A, a change amount ΔA of the performance influencing pre-element value changes, the value is A+ΔA, and the realization probability is J+ΔJ %. Therefore, it is possible to acquire the realization probability from the success probability distribution obtained by determining the performance pr-status value, which is the value of the performance influencing pre-element for each project, and substituting it into the probability distribution derivation function, and it is possible to acquire the influence degree for each performance influencing pre-element by dividing the performance pre-state value ΔA by the realization probability ΔJ obtained by changing the value of the performance pre-state value by ΔA to the same probability distribution derivation function. When acquiring the influence degree of one performance pre-status value, other performance pre-status values are fixed as values input first to the probability distribution derivation function. The influence degree is acquired one by one from the performance pre-status value.

Further, the influence degree of the performance influencing pre-element on the realization probability may be stored in advance as information for each performance influencing pre-element, or may be acquired by calculating each time as described above. The influence degree also generally changes by the value of the performance influencing pre-element, i.e., the performance pre-status value. This is because the gradient of the influence degree changes not only by the type of the performance influencing pre-element, but also by whether the value of the performance influencing pre-element has enough room to grow for the success of the project or saturation for the success of the project.

<Third Embodiment: Advice Acquisition Rule Holding Unit>

The advice acquisition rule holding unit 0709 holds an advice acquisition rule which is a rule for acquiring an advice on the performance influencing pre-element assuming the performance pre-status value in order to improve the realization probability. Here, “assuming the performance pre-status value” is an advice for further improving the performance pre-status value, and the content of the advice may be different depending on the performance pre-status value. For example, there are a case 1 in which the inputable capital amount is 500 million yen and a case 2 in which the inputable capital amount is 1 billion yen. When the probability of successful realization of the project increases by 10% around 500 million yen and by 5% around 1 billion yen in the inputable capital amount per unit, in the former, the probability of realization increases by 10% with an increase in inputable capital of 100 million yen, while in the latter, it is 5%. If the probability of realization is to be increased by 15%, in the former, an advice for securing additional inputable capital of 150 million yen is provided. In the latter, an advice for securing additional inputable capital of 300 million yen is required, and hence the quality of advice may differ between the two cases. For example, in case 1, additional investment from the parent company may be the advice, and in the latter, capital increase may be the advice.

In this way, the appropriate advice may be different depending on the value of the assumed performance pre-status value and the value of the target realization probability, and the rule for selecting the advice held in accordance with the performance pre-status value and the target realization probability is the advice acquisition rule. The advice acquisition rule is configured to acquire advice identification information which identifies the advice to be acquired by a function of the performance influencing pre-element, its performance pre-status value, and the target realization probability. Therefore, it is preferable that the project success probability calculation system 0700 has the advice acquisition rule holding unit 0709 which holds a large number of advices in association with the advice identification information.

The advice acquiring unit 0710 acquires an advice on the performance influencing pre-element based on the acquired influence degree and the advice acquisition rule. As described above, this “influence degree” changes according to the performance pre-status value associated with the performance influencing pre-element. When the advice is acquired without setting the target of the realization probability, the variable assigned to the advice acquisition rule is only the influence degree for each performance influencing pre-element, but when setting the target of the realization probability, it is preferable that the advice acquisition rule is configured so that a difference value between the target of the realization probability and the current realization probability or the current realization probability itself becomes a variable assigned to the advice acquisition rule.

Further, since it is conceivable that the advice acquiring unit 0710 selects the performance influence pre-elements in order of higher influence degree and acquires the advice using the advice acquisition rule, it is preferable that when acquiring the advice, it acquires the identification information of the performance influencing pre-elements in order of the influence degree and acquires the advice by selecting, for example, the top N (where N is a natural number) performance influencing pre-elements (identification information).

Further, when the project manager or the like specifies the performance influencing pre-element and asks for the acquisition of advice, it is also possible to configure so that an input receiving unit (not illustrated) for the required advice performance influencing pre-element is provided to acquire the performance influencing pre-element identification information, and the advice is acquired using the advice acquisition rule related to the acquired performance influencing pre-element.

<Third Embodiment: Advice Outputting Unit>

The advice outputting unit 0711 outputs the acquired advice. The output of the advice may be configured such that the advice is selectively selected from the held advice, or it may be configured such that a plurality of acquired advice are combined to output the advice. The performance influencing pre-elements may be linked to each other, and in such a case, advices can be aggregated into an advice aggregating unit (not illustrated) to summarize an advice briefly and output the advice. The advice aggregation unit holds attribute identification information and syntax identification information of the advice in accordance with the advice identification information, and it is conceivable to aggregate the advices using an advice aggregation rule which aggregates the advices in accordance with these information associated with a plurality of acquired advices.

It is preferable that the advice aggregation rule is held so as to be determined according to the advice identification information, the attribute identification information associated with the advice identification information, and the syntax identification information. In addition to a display and a printer, the advice can be output by electronic mail or voice. In addition, it is also possible to configure the advice outputting unit 0711 to output the advice according to the contents of an agenda in accordance with audio information of a conference or the like. It is preferable that the advice outputting unit 0711 analyzes the voice of the conference by artificial intelligence, etc., and is configured to discriminate what kind of thing becomes an agenda on which performance influencing pre-element, and to automatically output the related advice.

<Third Embodiment: Hardware Configuration>

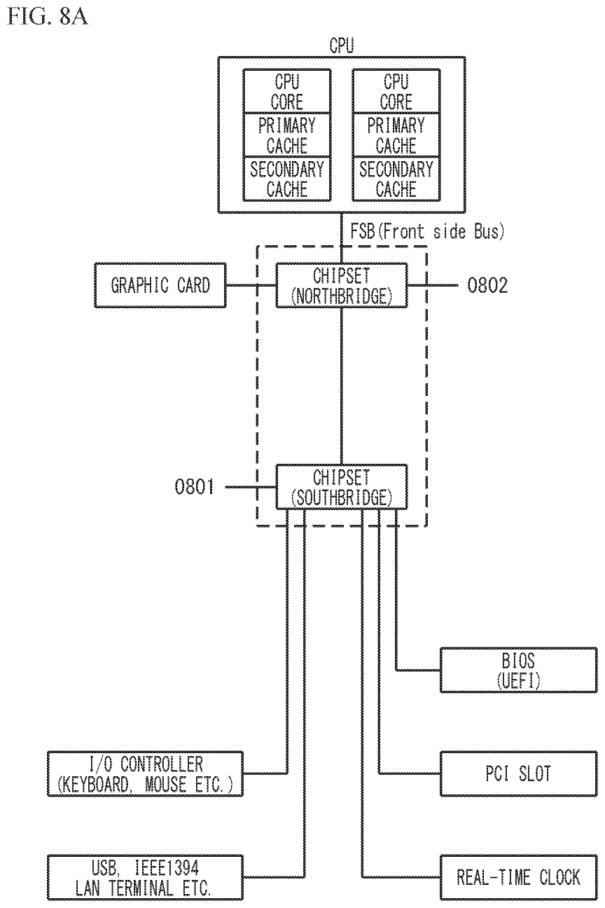

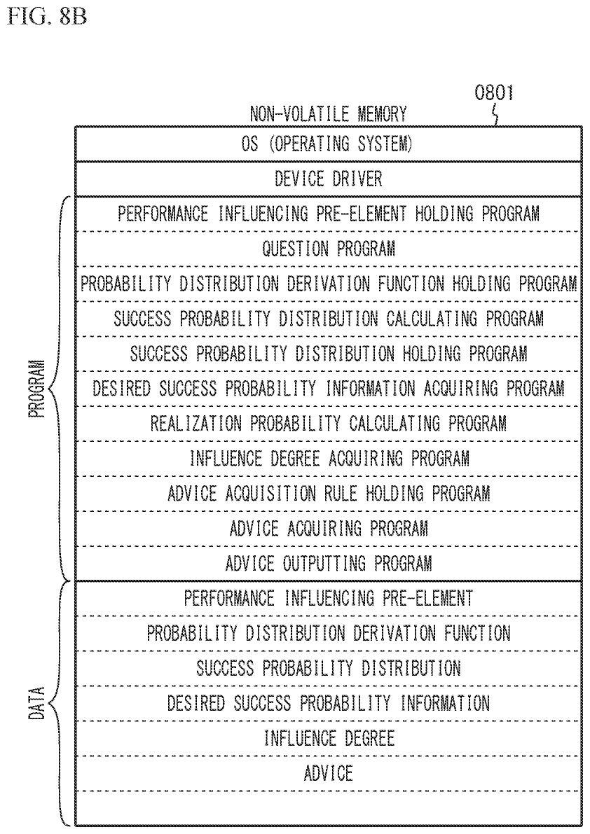

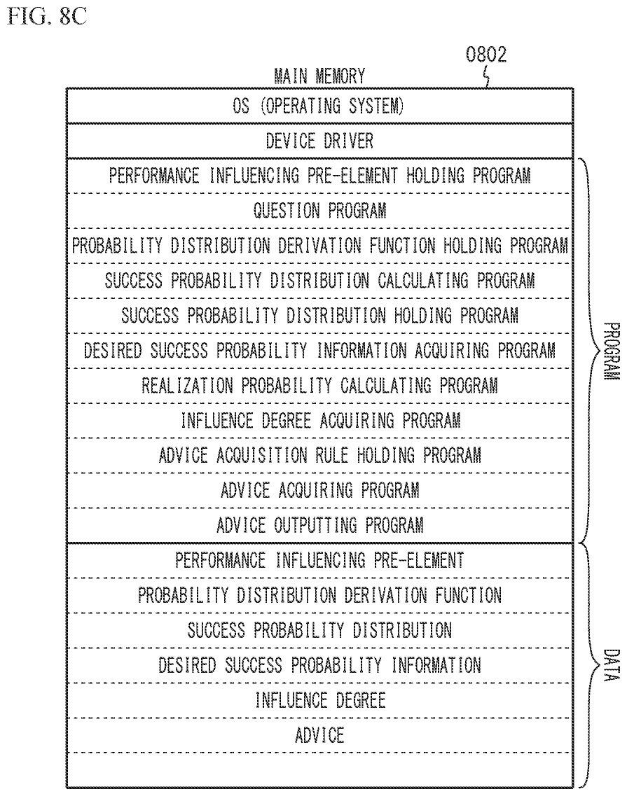

FIGS. 8A to 8C are diagrams illustrating a hardware configuration of the project success probability calculation system according to the third embodiment. As illustrated in FIGS. 8A to 8C, a computer includes a chipset, a CPU, a non-volatile memory, a main memory, various buses, a BIOS (Basic Input Output System), various interfaces, a real-time clock, and the like, which are configured on a motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 8A to 8C, the non-volatile memory includes a “performance influencing pre-element holding program” configured to hold a performance influencing pre-element which is a pre-element that influences the performance of a project and is empirically known to influence the success of the project; a “question program” configured to output a question for associating a performance pre-status value with the performance influencing pre-element assuming a specific project in which the project is specifically specified and prompt an input, wherein the performance pre-status value is one or more of a numerical value which is a value of the specific project, presence or absence, YES or NO, a level, and an option; a “probability distribution derivation function holding program” configured to hold a probability distribution derivation function which is a function for calculating a probability distribution of success of the specific project using the performance pre-status value associated with the performance influencing pre-element; a “success probability distribution calculating program” configured to calculate a success probability distribution of the specific project receiving the input by the question unit 0702, based on the performance pre-status value associated with the performance influencing pre-element obtained by the input to the question unit 0702 and the probability distribution derivation function held in the probability distribution derivation function holding unit 0703; a “success probability distribution holding program” configured to hold the calculated success probability distribution; a “desired success probability information acquiring program” configured to acquire desired success probability information which is information on a desired success probability; and a “realization probability calculating program” configured to calculate a realization probability which is a probability of realizing the desired success probability based on the held success probability distribution and the acquired desired success probability information. These programs are read into the main memory based on the execution instruction of the series of programs, and these programs are executed based on the operation start instruction.

In this computer, the non-volatile memory, the main memory, the CPU, and the interfaces (for example, a display, a keyboard, communication, etc.) are connected to the bus line so that they can communicate with each other. Further, the non-volatile memory includes an “influence degree acquiring program” configured to acquire an influence degree of the performance pre-status value associated with the performance influencing pre-element on the realization probability, an “advice acquisition rule holding program” configured to hold an advice acquisition rule which is a rule for acquiring an advice on the performance influencing pre-element assuming the performance pre-status value in order to improve the realization probability; an “advice acquiring program” configured to acquire an advice on the performance influencing pre-element based on the acquired influence degree and the advice acquisition rule, and an “advice outputting program” configured to output the acquired advice.

<Third Embodiment: Flow of Process>

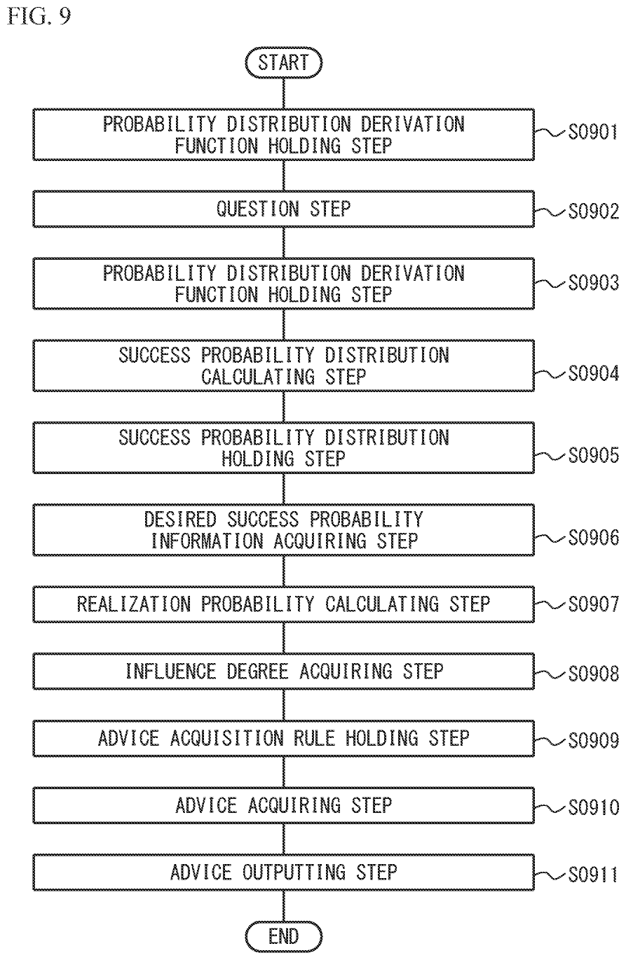

FIG. 9 is a flowchart illustrating a process when the project success probability calculation system according to the third embodiment is used. The flow of process of this embodiment includes a performance influencing pre-element holding step S0901 configured to hold a performance influencing pre-element which is a pre-element that influences the performance of a project and is empirically known to influence the success of the project; a question step S0902 configured to output a question for associating a performance pre-status value with the performance influencing pre-element assuming a specific project in which the project is specifically specified and prompt an input, wherein the performance pre-status value is one or more of a numerical value which is a value of the specific project, presence or absence, YES or NO, a level, and an option; a probability distribution derivation function holding step S0903 configured to hold a probability distribution derivation function which is a function for calculating a probability distribution of success of the specific project using the performance pre-status value associated with the performance influencing pre-element; a success probability distribution calculating step S0904 configured to calculate a success probability distribution of the specific project receiving the input by the question step S0902, based on the performance pre-status value associated with the performance influencing pre-element obtained by the input to the question step S0902 and the probability distribution derivation function held in the probability distribution derivation function holding step S0903; a success probability distribution holding step S0905 configured to hold the calculated success probability distribution; a desired success probability information acquiring step S0906 configured to acquire desired success probability information which is information on a desired success probability; a realization probability calculating step S0907 configured to calculate a realization probability which is a probability of realizing the desired success probability based on the held success probability distribution and the acquired desired success probability information, an influence degree acquiring step S908 configured to acquire an influence degree of the performance pre-status value associated with the performance influencing pre-element on the realization probability; an advice acquisition rule holding step S0909 configured to hold an advice acquisition rule which is a rule for acquiring an advice on the performance influencing pre-element assuming the performance pre-status value in order to improve the realization probability; an advice acquiring step S0910 configured to acquire an advice on the performance influencing pre-element based on the acquired influence degree and the advice acquisition rule; and an advice outputting step S0911 configured to output the acquired advice. The steps S0901 to S0907 except for the influence degree acquiring step S908, the advice acquisition rule holding step S0909, the advice acquiring step S0910 and the advice outputting step S0911 are the same as those of the second embodiment.

The influence degree acquiring step S908 acquires the influence degree of the performance pre-status value associated with the performance influencing pre-element on the realization probability.

The advice acquisition rule holding step S0909 holds the advice acquisition rule which is the rule for acquiring the advice on the performance influencing pre-element assuming the performance pre-status value in order to improve the realization probability.

The advice acquiring step S0910 acquires the advice on the performance influencing pre-element based on the acquired influence degree and the advice acquisition rule.

The advice outputting step S0911 outputs the acquired advice.

The various programs described in the first to third embodiments can be recorded in a non-transitory computer-readable storage medium (except for a carrier wave). When the program is distributed, it is sold in the form of a portable storage medium such as a DVD (Digital Versatile Disc) or a CD-ROM (Compact Disc Read Only Memory) on which the program is recorded. It is also possible to store the programs in a storage device of a computer and transfer the programs from the computer to another computer via a network.

What is claimed is:

1. A project success probability calculation system comprising:
a performance influencing pre-element holder configured to hold a performance influencing pre-element which is a pre-element that influences the performance of a project and is empirically known to influence the success of the project;
a questioner configured to output a question for associating a performance pre-status value with the performance influencing pre-element assuming a specific project in which the project is specifically specified and prompt an input, wherein the performance pre-status value is one or more of a numerical value which is a value of the specific project, presence or absence, YES or NO, a level, and an option;
a probability distribution derivation function holder configured to hold a probability distribution derivation function which is a function for calculating a probability distribution of success of the specific project using the performance pre-status value associated with the performance influencing pre-element;
a success probability distribution calculator configured to calculate a success probability distribution of the specific project receiving the input by the questioner, based on the performance pre-status value associated with the performance influencing pre-element obtained by the input to the questioner and the probability distribution derivation function held in the probability distribution derivation function holder, and
a success probability distribution holder configured to hold the calculated success probability distribution.

2. The project success probability calculation system according to claim 1, further comprising:
a desired success probability information acquirer configured to acquire desired success probability information which is information about a desired success probability; and
a realization probability calculator configured to calculate a realization probability which is a probability of realizing the desired success probability based on the held success probability distribution and the acquired desired success probability information.

3. The project success probability calculation system according to claim 2, further comprising:
an influence degree acquirer configured to acquire an influence degree of the performance pre-status value associated with the performance influencing pre-element on the realization probability;
an advice acquisition rule holder configured to hold an advice acquisition rule which is a rule for acquiring an advice on the performance influencing pre-element assuming the performance pre-status value in order to improve the realization probability;
an advice acquirer configured to acquire an advice on the performance influencing pre-element based on the acquired influence degree and the advice acquisition rule, and
an advice outputter configured to output the acquired advice.

4. The project success probability calculation system according to claim 1, wherein
the probability distribution derivation function is a function corrected by a combination of machine learning and Bayesian statistics.

5. A method of calculating a project success probability executed by a computer to execute a process, the process comprising:
holding a performance influencing pre-element which is a pre-element that influences the performance of a project and is empirically known to influence the success of the project;
outputting a question for associating a performance pre-status value with the performance influencing pre-element assuming a specific project in which the project is specifically specified and prompting an input, wherein the performance pre-status value is one or more of a numerical value which is a value of the specific project, presence or absence, YES or NO, a level, and an option;
holding a probability distribution derivation function which is a function for calculating a probability distribution of success of the specific project using the performance pre-status value associated with the performance influencing pre-element;
calculating a success probability distribution of the specific project receiving the input, based on the performance pre-status value associated with the performance influencing pre-element obtained by the input and the held probability distribution derivation function; and
holding the calculated success probability distribution.

6. The method of calculating the project success probability according to claim 5, wherein
the process further comprises:
acquiring desired success probability information which is information about a desired success probability; and
calculating a realization probability which is a probability of realizing the desired success probability based on the held success probability distribution and the acquired desired success probability information.

7. The method of calculating the project success probability according to claim 6, wherein
the process further comprises:
acquiring an influence degree of the performance pre-status value associated with the performance influencing pre-element on the realization probability;
holding an advice acquisition rule which is a rule for acquiring an advice on the performance influencing pre-element assuming the performance pre-status value in order to improve the realization probability;
acquiring an advice on the performance influencing pre-element based on the acquired influence degree and the advice acquisition rule; and
outputting the acquired advice.

8. The method of calculating the project success probability according to claim 5, wherein
the probability distribution derivation function is a function corrected by a combination of machine learning and Bayesian statistics.

9. A non-transitory computer-readable medium having stored therein a program for causing a computer to execute a process, the process comprising:
holding a performance influencing pre-element which is a pre-element that influences the performance of a project and is empirically known to influence the success of the project;
outputting a question for associating a performance pre-status value with the performance influencing pre-element assuming a specific project in which the project is specifically specified and prompting an input, wherein the performance pre-status value is one or more of a numerical value which is a value of the specific project, presence or absence, YES or NO, a level, and an option;
holding a probability distribution derivation function which is a function for calculating a probability distribution of success of the specific project using the performance pre-status value associated with the performance influencing pre-element;
calculating a success probability distribution of the specific project receiving the input, based on the performance pre-status value associated with the performance influencing pre-element obtained by the input and the held probability distribution derivation function; and
holding the calculated success probability distribution.

10. The non-transitory computer-readable medium according to claim 9, wherein
the process further comprises:
acquiring desired success probability information which is information about a desired success probability; and
calculating a realization probability which is a probability of realizing the desired success probability based on the held success probability distribution and the acquired desired success probability information.

11. The non-transitory computer-readable medium according to claim 10, wherein
the process further comprises:
acquiring an influence degree of the performance pre-status value associated with the performance influencing pre-element on the realization probability;
holding an advice acquisition rule which is a rule for acquiring an advice on the performance influencing pre-element assuming the performance pre-status value in order to improve the realization probability;
acquiring an advice on the performance influencing pre-element based on the acquired influence degree and the advice acquisition rule, and
outputting the acquired advice.

12. The non-transitory computer-readable medium according to claim 9, wherein
the probability distribution derivation function is a function corrected by a combination of machine learning and Bayesian statistics.

13. A project success probability calculation system comprising:
a performance influencing pre-element identification information holder configured to hold performance influencing pre-element identification information for identifying a performance influencing pre-element which is a pre-element that influences the performance of a project and is empirically known to influence the success of the project;
a questioner configured to output a question for associating a performance pre-status value with the performance influencing pre-element identification information assuming a specific project in which the project is specifically specified and prompt an input, wherein the performance pre-status value is one or more of a numerical value which is a value of the specific project, presence or absence, YES or NO, a level, and an option;
a probability distribution derivation function holder configured to hold a probability distribution derivation function which is a function for calculating a probability distribution of success of the specific project using the performance pre-status value associated with the performance influencing pre-element identification information;
a success probability distribution calculator configured to calculate a success probability distribution of the specific project receiving the input by the questioner, based on the performance pre-status value associated with the performance influencing pre-element identification information obtained by the input to the questioner and the probability distribution derivation function held in the probability distribution derivation function holder; and
a success probability distribution holder configured to hold the calculated success probability distribution.
